(19) United States
(12) Patent Application Publication
(10) Pub. No.: US 2026/0035550 A1
(43) Pub. Date: Feb. 5, 2026

(54) POLYOLEFIN COMPOSITIONS OBTAINED FROM RECYCLED POLYOLEFINS

(71) Applicant: Basell Poliolefine Italia S.r.l., Milano (IT)

(72) Inventors: Claudio Cavalieri, Ferrara (IT); Cristina Cova, Ferrara (IT)

(73) Assignee: Basell Poliolefine Italia S.r.l., Milano (IT)

(21) Appl. No.: 19/099,088

(22) PCT Filed: Jul. 11, 2023
(86) PCT No.: PCT/EP2023/069218

§ 371 Date: Jan. 28, 2025

(30) Foreign Application Priority Data
Aug. 4, 2022 (EP) 22188652.6

(51) Int. Cl. C08L 23/12

(52) U.S. Cl. CPC C08L 23/12; C08L 2203/16; C08L 2205/035; C08L 2207/20

(57) ABSTRACT

A propylene polymer composition made from or containing:
A) 50 wt % to 80 wt % of a propylene homopolymer or a propylene ethylene copolymer; and
B) 50 wt % to 20 wt % of a blend made from or containing:
T1) from 20 wt % to 40 wt % of a recycled composition containing:
   (T1a) at least 70 wt % of a propylene copolymer containing from 1 to 7% by weight of ethylene;
   (T1b) from 5 wt % to 29 wt % of a styrenic block copolymer (SBC) and, optionally,
   (T1c) from 1 wt % to 15 wt % by weight of an ethylene homopolymer or copolymer containing up to 30 wt % of a C₃-C₁₀ alpha olefin; and
T2) from 60 wt % to 80 wt % of a recycled composition containing a recycled styrene block copolymer (r-SBC);
the sum of the amount of T1 and T2 being 100;
the sum of the amount of A) and B) being 100.

### FIELD OF THE INVENTION

In general, the present disclosure relates to the field of chemistry. More specifically, the present disclosure relates to polymer chemistry. In particular, the present disclosure relates to soft polypropylene compositions made from or containing recycled elastomeric material.

### BACKGROUND OF THE INVENTION

Polyolefin compositions, having elastic properties and thermoplastic behavior, are used in many application fields. In some instances, the polyolefin compositions are selected for the compositions' chemical inertia, mechanical properties, and nontoxicity. In some instances, the polyolefin compositions are prepared into finished products with the same techniques used for thermoplastic polymers. In some instances, the polyolefin compositions are used in the medical field, packaging, extrusion coating, and electrical wires and cables covering.

In some instances, polyolefin compositions raise concerns of sustainability because production is based on non-renewable sources.

Efforts to address issues of sustainability through polyolefin recycling have shown limited success because commercially available recycled products are contaminated with heterogeneous materials.

In some instances, polymer compositions made from or containing recycled materials are perceived as having lower reliability and lower performance with respect to compositions made of virgin polymers, in the absence of recycled materials.

### SUMMARY OF THE INVENTION

In a general embodiment, the present disclosure provides a propylene polymer composition, having a value of melt flow rate (ISO 1133-1 230° C./2.16 kg) ranging from 3.0 g/10 min to 70.0 g/10 min, made from or containing:
A) 50 wt % to 80 wt % of a propylene homopolymer or a propylene ethylene copolymer (a) containing up to 22.0 wt % of ethylene and (b) having a melt flow rate (ISO 1133-1 230° C./2.16 kg) ranging from 20.0 to 100.0 g/10′; and
B) 50 wt % to 20 wt % of a blend made from or containing:
T1) from 20 wt % to 40 wt % of a recycled composition containing:
   (T1a) at least 70 wt % of a propylene copolymer containing from 1 wt % to 15 wt % of ethylene;
   (T1b) from 5 wt % to 29 wt % of a styrenic block copolymer (SBC) and, optionally,
   (T1c) from 1 wt % to 15 wt % of an ethylene homopolymer or copolymer containing up to 30 wt % of a C₃-C₁₀ alpha olefin;
the sum of the amount of T1a, T1b and T1c being 100; and
T2) from 60 wt % to 80 wt % of a recycled composition containing a recycled styrene block copolymer (r-SBC), having a melt flow rate (ISO 1133-1 230° C./2.16 kg) from 0.5 to 15.0 g/10 min,
the sum of the amount of T1 and T2 being 100;
the sum of the amount of A) and B) being 100.

### DETAILED DESCRIPTION OF THE INVENTION

In some embodiments, the present disclosure provides a propylene polymer composition, having a value of melt flow rate (ISO 1133 230° C./2.16 kg) ranging from 3.0 g/10 min to 70.0 g/10 min; alternatively from 15.0 g/10 min to 45.0 g/10 min; alternatively from 20.0 g/10 min to 35.0 g/10 min, made from or containing:
A) 50 wt % to 80 wt %, alternatively 55 wt % to 75 wt %; alternatively 58 wt % to 72 wt %; alternatively from 55 to 65 wt %, of a propylene homopolymer or a propylene ethylene copolymer (a) containing up to 22 wt %; alternatively up to 12 wt %; alternatively up to 7% wt, of ethylene and (b) having a melt flow rate (ISO 1133 230° C./2.16 kg) ranging from 20.0 to 100.0 g/10 min; alternatively from 60.0 to 90.0 g/10 min; alternatively from 65.0 to 85.0 g/10 min; and
B) 20 wt % to 50 wt %; alternatively from 25 wt % to 45 wt %; alternatively from 28 wt % to 42 wt %; alternatively from 35 wt % to 45 wt %, of a blend made from or containing:
T1) from 20 wt % to 40 wt %; alternatively from 25 wt % to 35 wt %; alternatively from 28 wt % to 32 wt %, of a recycled composition containing:
   (T1a) at least 70 wt %, alternatively from 75 wt % to 90 wt %, of a propylene copolymer containing from 1 wt % to 15 wt %, alternatively from 1 wt % to 7 wt %, of ethylene;
   (T1b) from 5 wt % to 29 wt %, alternatively from 7 wt % to 25 wt %, of a styrenic block copolymer (SBC) and, optionally,
   (T1c) from 1 wt % to 15 wt %, alternatively from 2 wt % to 4 wt %, of an ethylene homopolymer or copolymer containing up to 30% wt of a C₃-C₁₀ alpha olefin; the sum of the amounts of T1a, T1b and T1c being 100; and
T2) from 60 wt % to 80 wt %; alternatively from 65 wt % to 75 wt %, alternatively from 68 wt % to 72 wt %, of a recycled composition containing a recycled styrene block copolymer (r-SBC), having a melt flow rate (ISO 1133 230° C./2.16 kg) from 0.5 to 15 g/10 min,
the sum of the amounts of T1 and T2 being 100;
the sum of the amounts of A) and B) being 100.

As used herein, the term “copolymer” refers to both polymers with two different recurring units and polymers with more than two different recurring units, such as terpolymers, in the chain. As used herein, the term “ambient or room temperature” refers to a temperature of 25° C.

As used herein, the term “crystalline propylene polymer” refers to a propylene polymer having an amount of isotactic pentads (mmmm), measured by ¹³C-NMR on the fraction insoluble in xylene at 25° C., higher than 70 molar %. As used herein, the term “elastomeric” polymer refers to a polymer having solubility in xylene at ambient temperature higher than 50 wt %.

As used herein, the term “consisting essentially of” refers to, in connection with a polymer or polymer composition, in addition to the specified components, the polymer or polymer composition may be further made from or containing other components, provided that the characteristics of the polymer or of the polymer composition are not materially affected by the presence of the other components. In some embodiments, the other components are selected from the group consisting of catalyst residues, antistatic agents, melt stabilizers, light stabilizers, antioxidants, and antiacids.

The features of the components forming the polypropylene composition are not inextricably linked to each other. In some embodiments, a level of a feature does not involve the same level of the remaining features of the same or different components. In some embodiments, any component (A) to (B) and any range of features of components (A) to (B) are combined with any range of one or more of the features of components (A) to (B) and with any possible additional component, and the component's features.

In some embodiments, component A) is a virgin resin. In some embodiments, component A is propylene homopolymer.

In some embodiments, the melting temperature, determined via DSC, of the component A) ranges from 135° C. to 165° C. In some embodiments, component A) is a homopolymer, having the melting temperature, determined via DSC, ranging from 155° C. to 165° C. In some embodiments, component A) is a copolymer, having the melting temperature, determined via DSC, ranging from 135° C. to 155° C.

In some embodiments, component A) is prepared by polymerizing propylene, optionally in mixture with ethylene in the presence of a catalyst made from or containing the product of the reaction between:
i) a solid catalyst component made from or containing Ti, Mg, Cl, and an internal electron donor compound;
ii) an alkylaluminum compound and,
iii) an external electron-donor compound having the formula:
(R⁷)ₐ(R⁸)_{b}Si(OR⁹)_{c}, where a and b are integers from 0 to 2, c is an integer from 1 to 4 and the sum (a+b+c) is 4; R⁷, R⁸, and R⁹ are alkyl, cycloalkyl, or aryl radicals with 1-18 carbon atoms optionally containing heteroatoms.

In some embodiments, the internal donor is selected from the esters of mono or dicarboxylic organic acids such as benzoates, malonates, phthalates, and certain succinates. In some embodiments, the internal donors are as described in U.S. Pat. No. 4,522,930A, European Patent No. 045977A2 and Patent Cooperation Treaty Publication Nos. WO 00/63261 and WO 01/57099. In some embodiments, the internal donor is selected from the group consisting of phthalic acid esters and succinate acids esters. In some embodiments, the internal donor is an alkylphthalate. In some embodiments, the alkylphthalate is selected from the group consisting of diisobutyl phthalate, dioctyl phthalate, diphenyl phthalate, and benzyl-butyl phthalate.

In some embodiments, the particles of solid component (i) have substantially spherical morphology and an average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the amount of Mg ranges from 8 to 30 wt %, alternatively from 10 to 25 wt. %.

In some embodiments, the amount of Ti ranges from 0.5 to 7 wt %, alternatively from 0.7 to 5 wt. %.

In some embodiments, the solid catalyst component (i) is prepared by reacting a titanium compound of formula Ti(OR)q-yXy, where q is the valence of titanium and y is a number between 1 and q, with a magnesium chloride deriving from an adduct of formula MgCl2·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct, thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the resulting adduct is directly reacted with Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and maintained at this temperature for 0.5-2 hours. In some embodiments, the treatment with TiCl4 is carried out one or more times. In some embodiments, the electron donor compound is added during the treatment with TiCl₄.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichloride selected from the group consisting of AlEt₂Cl and Al₂Et₃Cl₃. In some embodiments, the alkyl-Al compound (ii) is a mixture including trialkylaluminums. In some embodiments, the Al/Ti ratio is higher than 1, alternatively ranges between 50 and 2000.

In some embodiments, the silicon compounds (iii) are wherein a is 1, b is 1, c is 2, at least one of R⁷ and R⁸ is selected from branched alkyl, cycloalkyl or aryl groups with 3-10 carbon atoms, optionally containing heteroatoms, and R9 is a C1-C10 alkyl group. In some embodiments, R₉ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, and methyl(3,3,3-trifluoro-n-propyl)dimethoxysilane. In some embodiments, the silicon compounds are wherein a is 0, c is 3, R8 is a branched alkyl or cycloalkyl group, optionally containing heteroatoms, and R9 is methyl. In some embodiments, the silicon compounds are selected from the group consisting of cyclohexyltrimethoxysilane, t-butyltrimethoxysilane and thexyltrimethoxysilane.

In some embodiments, the amount of external electron donor compound (iii) provides a molar ratio between the alkylaluminum compound and the external electron donor compound (iii) of from 0.1 to 200, alternatively from 1 to 100, alternatively from 3 to 50.

In some embodiments, the polymerization process is carried out in gas-phase, operating in one or more fluidized or mechanically agitated bed reactors, slurry polymerization using as diluent an inert hydrocarbon solvent, or bulk polymerization using the liquid monomer as a reaction medium. In some embodiments, the liquid monomer is propylene. In some embodiments, component A is subjected to a chemical treatment with organic peroxides, thereby lowering the average molecular weight and increasing the melt flow index.

In some embodiments, component (T1) originates from post-consumer waste (PostCW) or from pre-consumer waste (Pre-CW). In some embodiments, component (T1) originates from Pre-CW. The pre-consumer plastic is regarded as a plastic waste diverted from a manufacturing process, which is not reutilized, such as rework, regrind or scrap, and is not reincorporated in the same process that generated the pre-consumer plastic.

In some embodiments, component (T1a) is a random copolymer of propylene containing from 1 wt % to 6 wt %, alternatively from 2 wt % to 5 wt %, of ethylene derived units. In some embodiments, component (T1a) is derived from pre-consumer random PP material. In some embodiments, the pre-consumer random PP material is used for packaging.

In some embodiments, component (T1b) is selected from the group consisting of SBS and SEBS rubbers which are (partly) hydrogenated styrene-(ethylene-butadiene)-styrene block copolymers. In some embodiments, these polymers are triblock copolymers, having styrene at both extremities of the polymer chain with an internal polybutadiene or ethylene/butadiene, polyisoprene or hydrogenated polybutadiene or polyisoprene block.

In some embodiments, SBC copolymers are obtained via anionic polymerization. In some embodiments, the SBC copolymers are commercially available under the tradenames of Kraton and Tuftec. In some embodiments, the SBC copolymer is Kraton SEBS G1657MS. In some embodiments, component (T1b) is derived from a pre-consumer source.

In some embodiments, component (T1c) is present in an amount ranging from 1 wt % to 15 wt %, alternatively from 2 wt % to 4 wt %. In some embodiments, component (T1c) is an ethylene polymer containing up to 30 wt %, alternatively up to 20 wt %, alternatively up to 15 wt %, of a C₃-C₁₀ alpha olefin. In some embodiments, the alpha olefin is selected from the group consisting of butene-1, hexene-1 and octene-1.

In some embodiments, the ethylene polymer is selected from the group consisting of LDPE, LLDPE, VLDPE and polyolefin elastomers (POE) of pre-consumer source.

In some embodiments, the melt flow rate (ISO 1133-1 230° C./2.16 kg) of the whole component (T1) ranges from 0.5 to 30.0 g/10 min, alternatively from 1.0 to 25.0 g10 min, alternatively from 2.0 to 20.0 g/10 min.

In some embodiments, component (T1) has a tensile modulus lower than 500 MPa, alternatively lower than 400 MPa.

In some embodiments, component (T1) has a Charpy impact strength at 23° C. of 50-100 kJ/m², alternatively between 55-80 kJ/m². In some embodiments, component (T1) has a Charpy impact strength at −30° C. ranging from 5 to 20 kJ/m², alternatively from 6 to 15 kJ/m².

In some embodiments, component (T1) exhibits an elongation at break equal to or higher than 400%, alternatively in the range 500-600%.

In some embodiments, the melting temperature of component (T1) ranges from 140 to 160° C., alternatively from 145 to 155° C.

In some embodiments, component (T2) is a recycled styrene block copolymer (r-SBC).

In some embodiments, the styrene block copolymers have blocks derived from a diene, such as polybutadiene or polyisoprene blocks, and blocks derived from polystyrene or derivatives thereof. In some embodiments, the block copolymers are different types. In some embodiments, the types are selected from the group consisting of AB, ABA, and A(B)4 type. In some embodiments, the block copolymers are hydrogenated. In some embodiments, a mixture of block copolymers is used.

In some embodiments, the styrene block copolymer has formula A-B-A′, where A and A′ are each a thermoplastic endblock which includes a styrenic moiety and where B is an elastomeric polybutadiene, poly(ethylenebutylene), or poly(ethylenepropylene) midhlock. In some embodiments, the A and A′ endblocks of the block copolymer are identical and selected from the group consisting of polystyrene and polystyrene homologs. In some embodiments, the A and A′ endblocks are polystyrene or poly(alpha-methylstyrene).

In some embodiments, the styrene block copolymers are recycled styrene-butadiene-styrene block copolymers, referred to as r-SBS.

In some embodiments, the recycled styrene block copolymers have a pre-consumer waste origin. In some embodiments, the recycled styrene block copolymers include minor amounts of heterogeneous polymer or non-polymeric components.

In some embodiments, the recycled styrene block copolymer contains from 1 wt % to 15 wt %, alternatively from 3 wt % to 12 wt %, of other components selected from the group consisting of polyethylene, polypropylene and inorganic materials. In some embodiments, the inorganic materials are inorganic additives. In some embodiments, the recycled styrene block copolymer contains a propylene homopolymer, an ethylene polymer, and talc as an inorganic additive.

In some embodiments, the (r-SBC) has a melt flow rate (ISO 1133-1 230° C./2.16 kg) from 1.0 to 10.0 g/10 min, alternatively from 2.0 to 8.0 g/10 min.

In some embodiments, the r-SBC has a density ranging from 0.95 g/cm³ to 0.965 g/cm³, alternatively from 0.960 g/cm³ to 0.965 g/cm³ (ISO 1183-1). In some embodiments, the r-SBC has a Shore D lower than 45, alternatively lower than 40, alternatively lower than 30.

In some embodiments, the final composition made from or containing (a)+(b) is subjected to a chemical treatment with organic peroxides, thereby lowering the average molecular weight and increasing the melt flow index.

In some embodiments, component B is a recycled styrene block copolymer (r-SBC).

In some embodiments, the styrene block copolymers have blocks derived from a diene, such as polybutadiene or polyisoprene blocks, and blocks derived from polystyrene or derivatives thereof. In some embodiments, the block copolymers are different types. In some embodiments, the types are selected from the group consisting of AB, ABA, and A(B)4 type. In some embodiments, the block copolymers are hydrogenated. In some embodiments, a mixture of block copolymers is used.

In some embodiments, the styrene block copolymer has formula A-1B-A′, where A and A′ are each a thermoplastic endblock which includes a styrenic moiety and where B is an elastomeric polybutadiene, poly(ethylenebutylene) or poly(ethylenepropylene) mridblock. In some embodiments, the A and A′ endblocks of the block copolymer are identical and selected from the group consisting of polystyrene and polystyrene homologs. In some embodiments, the A and A′ endblocks are polystyrene or poly(alpha-methylstyrene).

In some embodiments, the styrene block copolymers are recycled styrene-butadiene-styrene block copolymers, referred to as r-SBS.

In some embodiments, the recycled styrene block copolymers have a pre-consumer waste origin. In some embodiments, the recycled styrene block copolymers include minor amounts of heterogeneous polymer or non-polymeric components.

In some embodiments, the recycled styrene block copolymer contains from 1 wt % to 15 wt %, alternatively from 3 wt % to 12 wt %, of other components selected from the group consisting of polyethylene, polypropylene and inorganic materials. In some embodiments, the inorganic materials are inorganic additives. In some embodiments, the recycled styrene block copolymer contains a propylene homopolymer, an ethylene polymer and talc as an inorganic additive.

In some embodiments, the (r-SBC) has a melt flow rate (ISO 1133-1 230° C./2.16 kg) from 1.0 to 10.0 g/10 min, alternatively from 2.0 to 8.0 g/10 min.

In some embodiments, the r-SBC has a density ranging from 0.95 g/cm³ to 0.965 g/cm³, alternatively from 0.960 g/cm³ to 0.965 g/cm³ (ISO 1183-1). In some embodiments, the r-SBC has a Shore D lower than 45, alternatively lower than 40, alternatively lower than 30.

In some embodiments, the whole polypropylene composition shows a tensile modulus value lower than that of component A). In some embodiments, the tensile modulus of the whole propylene polymer composition ranges from to 750 MPa to 1300 MKpa, alternatively from 800 to 1200 MPa.

In some embodiments, the whole polypropylene composition has a Charpy impact at 23° C. ranging from 15.0 Kj/m² to 5.0 Kj/m². In some embodiments, the whole polypropylene composition has a Charpy impact at 0° C. ranging from 3.0 Kj/m² to 7.0 Kj/m². In some embodiments, the whole polypropylene composition has a Charpy impact at −20° C. ranging from 5.0 Kj/m² to 2.0 Kj/m².

In some embodiments, the whole propylene composition is obtained by mechanical blending of the components (A) and (B).

In some embodiments, the final composition made from or containing the components (A) and (B) is further made from or containing other components selected from the group consisting of additives, fillers and pigments. In some embodiments, the other components are selected from the group consisting of nucleating agents, extension oils, mineral fillers, and other organic and inorganic pigments. In some embodiments, the other components are inorganic fillers. In some embodiments, the inorganic fillers are selected from the group consisting of talc, calcium carbonate and mineral fillers. In some embodiments, the fillers improve mechanical properties, such as flexural modulus and HDT. In some embodiments, talc has a nucleating effect.

In some embodiments, the nucleating agents are added in quantities ranging from 0.05 to 2% by weight, alternatively from 0.1 to 1% by weight, with respect to the total weight.

In some embodiments, the propylene polymer composition is extruded to form films or sheets for a variety of applications. In some embodiments, the sheets are for roofing applications.

In some embodiments, the present disclosure provides an extruded article made from or containing the propylene polymer composition. In some embodiments, the extruded article is a sheet for roofing applications.

The following examples are given to illustrate and not limit the present disclosure.

### EXAMPLES

### Characterizations

### Xylene-Soluble (XS) Fraction at 25° C.

2.5 g of polymer and 250 ml of xylene were introduced into a glass flask equipped with a refrigerator and a magnetic stirrer. The temperature was raised in 30 minutes up to the boiling point of the solvent. The resulting clear solution was then kept under reflux and stirred for 30 minutes. The closed flask was then kept for 30 minutes in a bath of ice and water, then in a thermostatic water bath at 25° C. for 30 minutes. The resulting solid was filtered on quick filtering paper. 100 ml of the filtered liquid were poured into a pre-weighed aluminum container, which was heated on a heating plate under nitrogen flow, thereby removing the solvent by evaporation. The container was then kept in an oven at 80° C. under vacuum until a constant weight was obtained. The weight percentage of polymer soluble in xylene at room temperature was then calculated.

The content of the xylene-soluble fraction is expressed as a percentage of the original 2.5 grams and then, by the difference (complementary to 100%), the xylene insoluble percentage (%).

### Melt Flow Rate (MFR)

Measured according to ISO 1133-1 at 190° C. or 230° C. with a load of 2.16 kg, as specified.

### Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket. This setup allowed for temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

Polydispersity index: Determined at a temperature of 200° C. by using a parallel plates rheometer model RMS-800 marketed by RHEOMETRICS (USA), operating at an oscillation frequency which increased from 0.1 rad/see to 100 rad/sec. From the crossover modulus, the P.I. was derived from the equation:

$$P . I . = 105 / Gc$$

wherein Gc is the crossover modulus which is defined as the value (expressed in Pa) at which G′=G″ wherein G′ is the storage modulus and G″ is the loss modulus.

### Ethylene (C₂) Content

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules 1982, 15, 4, 1150-1152) using the following equations:

$$\begin{matrix}\begin{matrix}PPP = 100 {T}_{ββ} / S & PPE = 100 {T}_{βδ} / S & EPE = 100 {T}_{δδ} / S \\ PEP = 100 {S}_{ββ} / S & PEE = 100 {S}_{βδ} / S & EEE = 100 ( 0.25 {S}_{γδ} + 0.5 {S}_{δδ} ) / S\end{matrix} \\ S = {T}_{ββ} + {T}_{βδ} + {T}_{δδ} + {S}_{ββ} + {S}_{βδ} + 0.25 {S}_{γδ} + 0.5 {S}_{δδ}\end{matrix}$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

### Samples for the Mechanical Tests

Samples were obtained according to ISO 1873-2:2007.
Charpy impact test was determined according to ISO 179-leA, and ISO 1873-2.
Elongation at yield: measured according to ISO 527.
Elongation at break: measured according To ISO 527.
Stress at break: measured according to ISO 527.
Tensile Modulus according to ISO 527-2.
Tear Resistance according to the method ASTM D 1004 on 1 mm-thick extruded sheets.
Crosshead speed: 51 mm/min; V-shaped die cut specimen.
Shore D on injection molded, compression molded plaques, and extruded sheets according to the method ISO 868 (15 sec).

### Melting Point and Crystallization Point

The melting point was measured by using a DSC instrument according to ISO 11357-3, at scanning rate of 20 C/min both in cooling and heating, on a sample of weight between 5 and 7 mg, under inert N₂ flow. Instrument was calibrated with Indium.

### EXAMPLES

### Component A)

Component A) was a homopolymer, which was commercially available as HA840R from LyondellBasell. The homopolymer was visbreaked with peroxides, thereby achieving an MFR of 70.0 g/10 min.

### Component T1)

Component T1 was a recycled composition made separately and having a MFR of 4.3 g/10 min, made of 80% wt of a recycled random propylene ethylene copolymer containing 4.5 wt % of ethylene, 15 wt % recycled SEBS and 5 wt % of recycled LLDPE.

### Component T2

Component T2 was a pre-consumer recycled SBS material, having a MFR of 4.1 g/10 min and 88 wt % of solubility in xylene at 25° C. The r-SBS also contained 3% wt of talc, 3% wt of propylene homopolymer and 4% wt of ethylene polymer. The characterization is reported in Table 1.

TABLE 1

| | T2 |
|---|---|
| MFR, g/10 min | 4.1 |
| Tensile Modulus; (N/mm²) | 42 |
| Shore D (15 sec) | 20 |
| Elongation at break, % | 570 |

### Example 1 and Comparative Examples 2 and 3

The polymer particles of component A) were introduced into an extruder (Berstorff extruder), wherein the polymer was mixed with various amounts of components T1 and T2 as reported in Table 2. 1000 ppm of M.S. 168, as an additive, was added. The polymer particles were extruded, under nitrogen atmosphere, in a twin screw extruder, at a rotation speed of 250 rpm and a melt temperature of 200-250° C. The characterization of the resulting composition is reported in Table 2.

TABLE 2

| | Ex 1 | Ex 2 | comp ex 3 | comp ex 4 |
|---|---|---|---|---|
| Component A | 60 | 70 | 60 | 60 |
| Component B | 40 | 30 | 40 | 40 |
| Component T1 (in B) | 30 | 30 | 100 | 0 |
| Component T2 (In B) | 70 | 70 | 0 | 100 |
| MFR, g/10 min | 22.2 | 29.3 | 24.5 | 24 |
| Tm ° C. | 160.6 | 161.3 | 161 | 162 |
| Tc ° C. | 118.9 | 119.7 | 118 | 119 |
| Tensile Modulus; (N/mm²) | 860 | 1060 | 1120 | 710 |
| Charpy impact 23° C. Kj/m² | 12 | 7.3 | 12 | 9.21 |
| Charpy impact 0° C. Kj/m² | 7.7 | 4.7 | 3 | 6 |
| Charpy impact −20° C. Kj/m² | 4.8 | 3.8 | 2 | 5.2 |
| D/T TT ° C. | <−50 | <−50 | −21 | <−50 |

What is claimed is:

1. A propylene polymer composition, having a value of melt flow rate (ISO 1133-1 230° C./2.16 kg) ranging from 3.0 g/10 min to 70.0 g/10 min, comprising:
A) 50 wt % to 80 wt %; of a propylene homopolymer or a propylene ethylene copolymer (a) containing up to 22% wt of ethylene and (b) having a melt flow rate (ISO 1133-1 230° C./2.16 kg) ranging from 20.0 to 100.0 g/10 min; and
B) 50 wt % to 20 wt % of a blend comprising:
T1) from 20 wt % to 40 wt % of a recycled composition containing:
(T1a) at least 70 wt % of a propylene copolymer containing from 1 wt % to 15 wt % of ethylene;
(T1b) from 5 wt % to 29 wt % of a styrenic block copolymer (SBC) and, optionally,
(T1c) from 1 wt % to 15 wt % of an ethylene homopolymer or copolymer containing up to 30 wt % of a C₃-C₁₀ alpha olefin;
the sum of the amount of T1a, T1b and T1c being 100; and
T2) from 60 wt % to 80 wt % of a recycled composition containing a recycled styrene block copolymer (r-SBC), having a melt flow rate (ISO 1133-1 230° C./2.16 kg) from 0.5 to 15 g/10 min,
the sum of the amount of T1 and T2 being 100;
the sum of the amount of A) and B) being 100.

2. The propylene polymer composition according to claim 1, wherein the component (A) ranges from 55 wt % to 75 wt % and component (B) ranges from 25 wt % to 45 wt %.

3. The propylene polymer composition according to claim 1, wherein T1 ranges from 25 wt % to 35 wt % and T2 ranges from 65 wt % to 75 wt %.

4. The propylene polymer composition according to claim 1, wherein
(T1a) ranges from 75 wt % to 90 wt %;
(T1b) ranges from 7 wt % to 25 wt % and, optionally,
(T1c) ranges from 2 wt % to 4 wt %.

5. The propylene polymer composition according to claim 1, having a melt flow rate (ISO 1133 230° C./2.16 kg) ranging from 15.0 g/10 min to 45.0 g/10 min.

6. The propylene polymer composition according to claim 1, wherein component (A) has a melt flow rate ranging from −60.0 to 90.0 g/10 min.

7. The propylene polymer composition according to claim 1, wherein component (A) is a propylene homopolymer.

8. The propylene polymer composition according to claim 1, wherein component (A) ranges from 58 wt % to 72 wt % and component B ranges from 28 wt % to 42 wt %.

9. The propylene polymer composition according to claim 1, wherein T1 ranges from 28 wt % to 32 wt % and T2 ranges from 68 wt % to 72 wt %.

10. The propylene polymer composition according to claim 1, wherein component (T2) includes minor amounts of heterogeneous polymers or non-polymeric components.

11. The propylene polymer composition according to claim 1, wherein component (T2) contains from 1 wt % to 15 wt % of other components selected from the group consisting of polyethylene, polypropylene and inorganic materials.

12. The propylene polymer composition according to claim 1, wherein component (T1a) is a random copolymer of propylene containing from 1 wt % to 6 wt % of ethylene derived units-.

13. The propylene polymer composition according to claim 1, wherein component (T1b) is selected from the group consisting of SBS and SEBS rubbers which are (partly) hydrogenated styrene-(ethylene-butadiene)-styrene block copolymers.

14. The propylene polymer composition according to claim 1, wherein component (T1c) is an ethylene polymer containing up to 30 wt % of a C₃-C₁₀ alpha olefin.

15. An extruded article obtained from the propylene polymer composition according to claim 1.
